(19) United States
(12) Patent Application Publication
(10) Pub. No.: US 2002/0080741 A1
(43) Pub. Date: Jun. 27, 2002

(54) Multiple wireless format phone system and method

(76) Inventor: Akihiko Toyoshima, Tokyo (JP)

Correspondence Address: Intellectual Property Departmnet, Sony Electronics Inc., 123 Tice Boulevard - MD T1-1, Woodcliff Lake, NJ, 07677, US

(21) Appl. No.: 09/972,760

(22) Filed: Oct. 5, 2001

Related U.S. Application Data
(60) Provisional application No. 60/240,011, filed on Oct. 13, 2000.

(51) Int. Cl. H04B 7/216

(52) U.S. Cl. 370/335; 370/342

(57) ABSTRACT

A multiple format wireless phone includes at least one wireless module which is similar in size, shape, and form factor as a Memory Stick™. The wireless module allows for wireless communication with digital storage functionality and may contain a wireless format for a region different than the one multiple format wireless phone currently operates within. In one embodiment, the wireless module includes operational data which includes an electronic serial number and a mobile station identification number, such that the multiple format wireless phone stores the operational data and can transmit and receive telephone calls in various regions utilizing one telephone number.

### FIELD OF THE INVENTION

This invention relates generally to the field of removable wireless modules. More particularly, this invention relates to a system and method for format and activation of a data storage and wireless transmission module for a wireless telephone.

### BACKGROUND OF THE INVENTION

The need for portability of data has increased over the years, and has spurred the development of removable memory devices. For example, Memory Stick™ is a removable data storage device made by Sony Corporation and is a recordable integrated circuit (IC) digital storage device having a storage capacity greater than a standard 3.5 inch floppy disk. Most importantly, Memory Stick™ is smaller than a stick of gum, very lightweight, and therefore ultra-portable. However, the need for accessability to people, information, and data has also increased despite the currently increased portability.

Due to cost and variations in support of wireless formats in various regions, a wireless telephone may only operate in a limited region and a user may therefore require the use of another wireless telephone for another regional wireless format. For each region which utilizes a different wireless format, the user must activate another wireless telephone. For example, a wireless telephone which operates in the United States of America will not operate in Japan, and visa versa. Therefore, as the need for accessability to people, information, and data increases it would be desirable to provide a wireless telephone with multiple wireless formats such that an increase in accessability and portability of the wireless telephone increases without increasing the cost or the number of wireless telephones necessary for multiple regional use.

### SUMMARY OF THE INVENTION

In view of the foregoing, a multiple wireless phone is provided for portability and accessability in multiple wireless formats.

In particular, in one embodiment a multiple wireless phone includes at least one wireless module which is similar in size, shape, and form factor as the current Memory Stick™. The wireless module allows for wireless communication with digital storage functionality and may contain a wireless format for a region different than the one the wireless phone currently operates within. In one embodiment, the wireless module includes operational data which includes an electronic serial number and a mobile station identification number, such that the multiple wireless phone stores the operational data and can transmit and receive telephone calls in various regions utilizing one telephone number.

These and other features and advantages of the invention will be understood upon the consideration of the following detailed description of the invention and accompanying drawings. The features of the invention believed to be novel are set forth with particularity in the appended claims. The invention itself however, both as to organization and method of operation, together with further objects and advantages thereof, may be best understood by reference to the following description taken in conjunction with the accompanying drawing.

### BRIEF DESCRIPTION OF THE DRAWING

The following detailed description, given by way of example, and not intended to limit the present invention solely thereto, will best be understood in conjunction with the accompanying drawings in which:

FIG. 1 is a block diagram of one embodiment of a wireless module.

FIG. 2A is a block diagram of an embodiment of the baseband signal processor circuit shown in FIG. 1.

FIG. 2B is a block diagram of another embodiment of the baseband signal processor circuit shown in FIG. 1.

FIG. 2C is a block diagram of a further embodiment of the baseband signal processor circuit shown in FIG. 1.

FIG. 3 is a flow diagram illustrating the steps of one embodiment of a specify process for the wireless module utilized in a multiple format wireless phone.

FIG. 4 is a flow diagram illustrating the steps of one embodiment of a determination process for utilization of the multiple format wireless phone.

### DETAILED DESCRIPTION OF THE INVENTION

While the present invention has been particularly shown and described with reference to an embodiment(s), it will be understood that various changes and modifications may be made without departing from the spirit and scope of this invention. It is intended that the appended claims be interpreted to cover the embodiments described herein and all equivalents thereto.

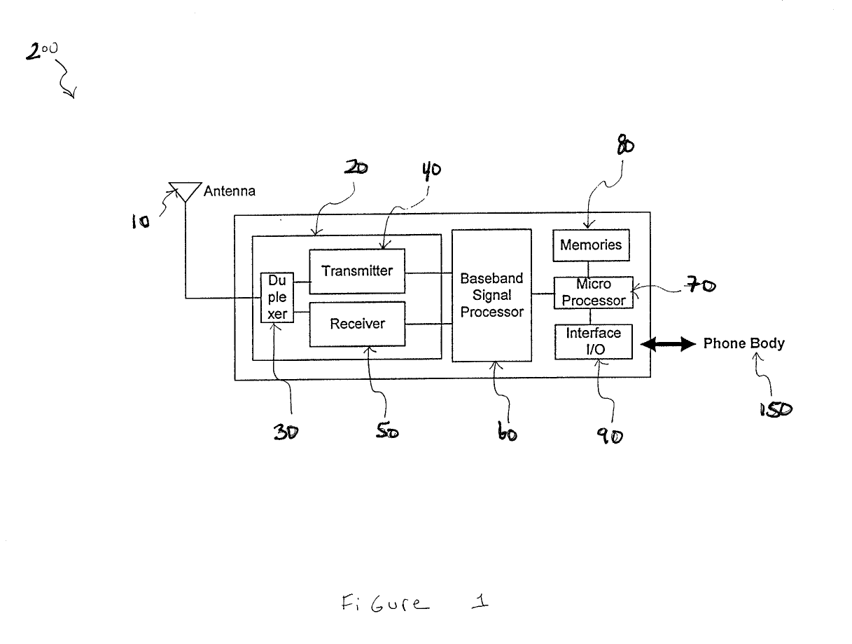

Turning now to FIG. 1, one embodiment of a wireless module 200 is shown. Wireless module 200 includes an antenna 10 connected to a transceiver circuit 20. Transceiver circuit 20 includes a duplexer 30, a transmitter 40, and a receiver 50. Transmitter 40 and receiver 50 of transceiver circuit 20 are connected to a baseband signal processor circuit 60. Baseband signal processor circuit 60 is connected to a microprocessor 70. Memories 80 and an interface input/output (I/O) 90 are also connected to microprocessor 70. A multiple format wireless phone body 150 is connected to wireless module 200 through interface I/O 90.

In operation, wireless module 200 receives a signal(s) containing data packets through antenna 10 and forwards the received signals and data packets to duplexer 30, through receiver 50, and to baseband signal processor circuit 60. The data packets/received signals will then be forwarded to microprocessor 70 and through interface I/0 90 to multiple format wireless phone 150. Wireless module 200 receives and transmits data packets/received signals utilizing at least one wireless format selected from the group consisting of CDMA ONE, CDMA 2000 1X, CDMA 2000 3X, CDMA 1X EV, Wideband CDMA, GSM, GPRS and EDGE. In case multiple format wireless phone 150 engages in simultaneous transmission and reception of data packets, duplexer 30 and memories 80 are utilized.

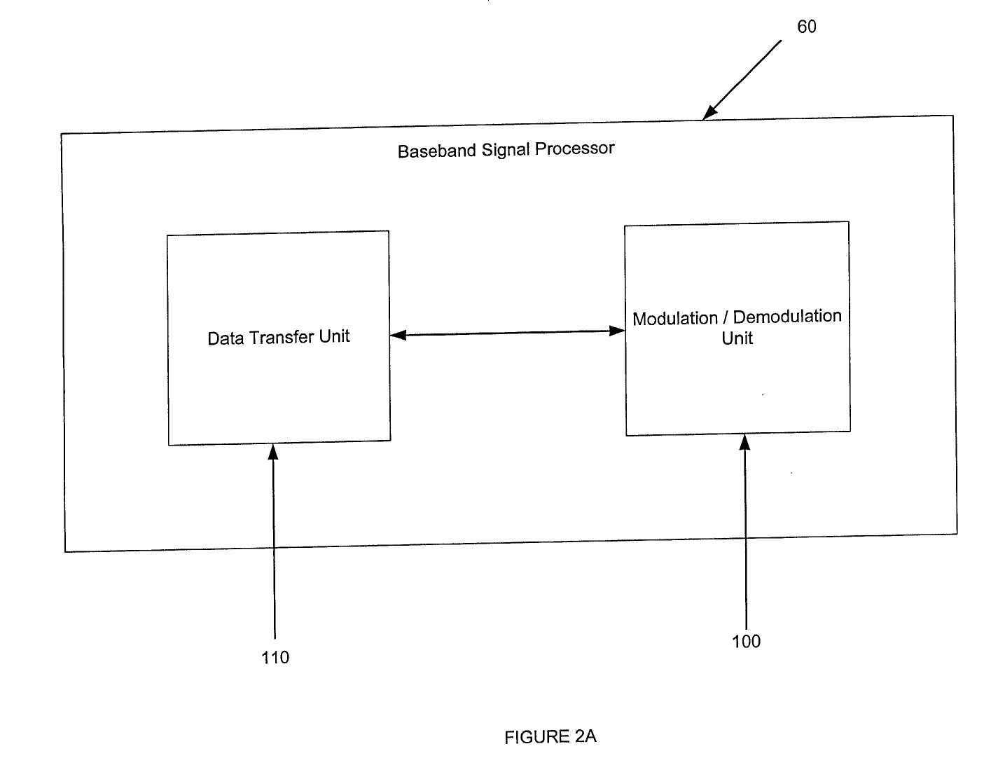

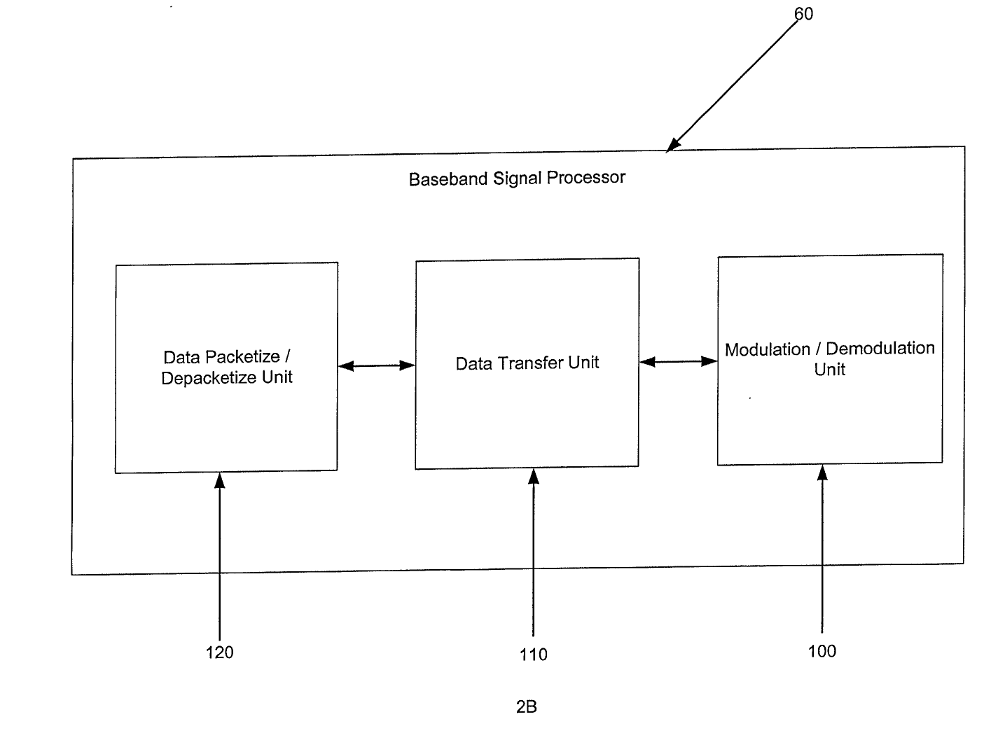

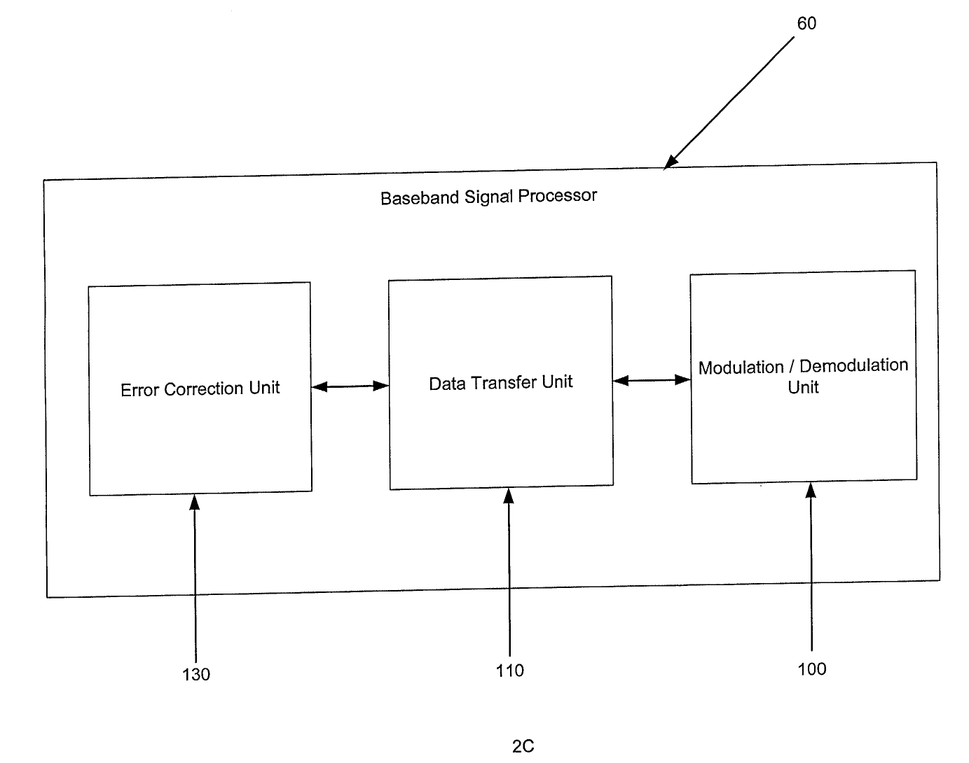

FIG. 2A shows one embodiment of baseband signal processor 60 (shown in FIG. 1) including a modulation/demodulation unit 100 connected to a data transfer unit 110. Modulation/demodulation unit 100 demodulates and converts the received signals to a baseband signal and supplies a demodulated baseband signal to data transfer unit 110 where data packets are extracted, e.g., an audio signal, a video signal, and control signals, from the received signals. Data transfer unit 110 supplies the extracted data packets to microprocessor 70 (shown in FIG. 1). In case multiple format wireless phone 150 engages in transmission of signals containing data packets, modulation/demodulation unit 100 modulates and converts the data packets into transmission signals which are sent to data transfer unit 110 and then to transmitter 40 and transceiver circuit 20 (shown in FIG. 1).

FIG. 2B shows another embodiment of baseband signal processor 60 (shown in FIG. 1) which includes an optional data packetize/depacketize unit 120 for packetizing/depacketizing transmission signals and received signals prior to sending transmission signals and received signals to transceiver circuit 20 and microprocessor 70 (shown in FIG. 1), respectively. Data packetize/depacketize unit 120 may be implemented by techniques well known to those skilled in the art.

In a further embodiment, referring to FIG. 2C, baseband signal processor 60 includes an error correction unit 130 for correcting data error prior to communication data to transceiver circuit 20 and microprocessor 70 (shown in FIG. 1). Error correction unit 130 may also be implemented by techniques well known to those skilled in the art. For example, wireless local area networks (LANs) typically experience higher error rates than wired LANs, which result in retransmission of data packets. In addition, the collision avoidance mechanism is not as efficient as collision detection used in Ethernet, especially with a large number of users. Therefore, packetization/depacketization and error correction results in a more efficient transmission in wireless environments.

FIGS. 2A through 2C show various embodiments of broadband signal processor 60 (shown in FIG. 1) for a wireless communication system. A wireless system eliminates many hardware requirements and adds mobility to a user. Generally, wireless communication may also be accomplished through the use of InfraRed (IR) or radio waves. The IEEE 802.11 and 802.11b specifications provide standards for both the InfraRed frequencies and the radio wave frequencies.

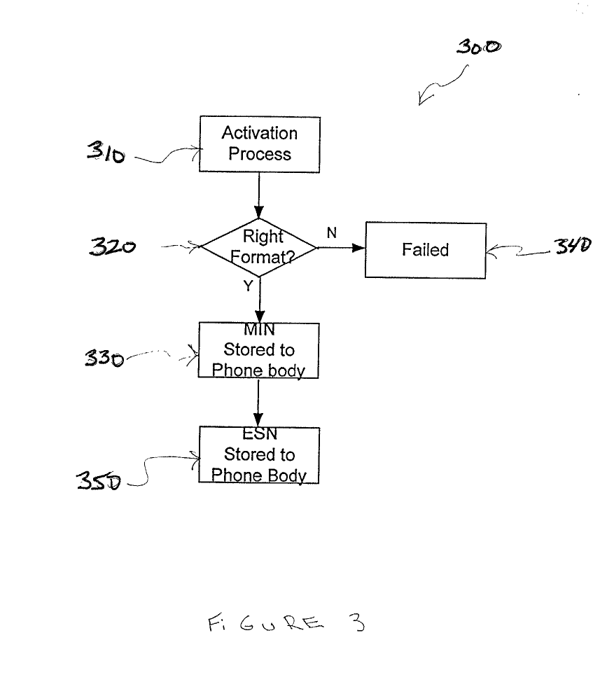

FIG. 3 depicts a flow diagram 300 of one embodiment of a specify process for wireless module 200 (shown in FIG. 1) provided to multiple format wireless phone 150 (shown in FIG. 1). As shown, an activation process 310 is a first step in the specify process for wireless module 200. Once activation process 310 is complete, wireless module 200 is ready for such format. The format for wireless module 200 is provided from at least one wireless format selected from the group consisting of IS-95B, CDMA 2000 1X, CDMA 1X EV, CDMA ONE, Wideband CDMA, GSM, GPRS and EDGE. Once formatting of wireless module 200 is accomplished, step 320 determines if wireless module 200 has the right format. In this step, for instance, multiple format wireless phone 150 may have to receive a signal during such period and my receive the signal or may not. If wireless module 200 operates properly in the region of operation, then the specify process progresses to step 330 where a mobile station identification number (MIN) (not shown) is stored to multiple format wireless phone 150. If wireless module 200 does not operate properly in the region of operation, then the specify process fails in step 340 and the formatting of wireless module 200 is begun again until wireless module 200 is properly formatted.

Flow diagram 300 illustrates the conclusion to one embodiment of the specify process for wireless module 200 by storing an electronic serial number (not shown) to multiple format wireless phone 150 in step 350. Wireless module 200 is provided the electronic serial number and in one embodiment stores the electronic serial number to multiple format wireless phone 150 for an automatic verification process. In one embodiment, wireless module 200 is also provided with the mobile station identification number, along with multiple format wireless phone 150 for security and verification processes.

In one embodiment, multiple format wireless phone 150 is configured to receive one wireless module 200. In another embodiment, multiple format wireless phone 150 is configured to receive more than one wireless module 200 so that operation in different regions utilizing different formats is possible and all transmissions and receptions will be to one MIN. In one embodiment, the electronic serial number and the MIN are operational data. In another embodiment, the operational data may be the electronic serial number, the MIN, and/or at least one wireless format and/or some other combination of some other device data. Again, because wireless module 200 is removably connected to multiple format wireless phone 150, some operational data may be necessary for security, verification, and/or operation processes.

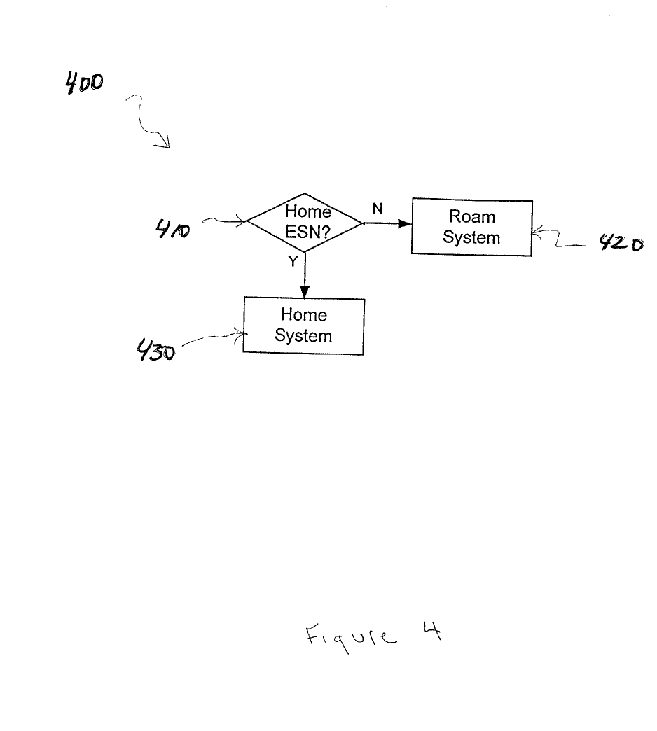

FIG. 4 depicts a flow diagram 400 of one embodiment of a determination process for utilization of wireless module 200 (shown in FIG. 1) in multiple format wireless phone 150 (shown in FIG. 1). As shown, a first step 410 in the determination process for wireless module 200 is whether module 200 is in the home wireless format or proper operational area. If wireless module 200 is not in a home area, multiple format wireless phone 150 will operate in a roam area in step 420. However, if wireless module 200 is in the home wireless format then multiple format wireless phone 150 will operate in the home system area in step 430. In a further embodiment, multiple format wireless phone 150 may bypass roam system step 420 and operate in another wireless format stored to another wireless module 200 or in its inherent wireless format.

Various other modifications and alterations in the structure and method of operation of this invention will be apparent to those skilled in the art, without departing from the scope and spirit of the invention. Although the invention has been described in connection with specified preferred embodiments, it should be understood that the invention as claimed should not be unduly limited to such specific embodiments. It is intended that the following claims describe the scope of the present invention and that the structures and methods within the scope of these claims and their equivalents be covered thereby.

What is claimed is:

1. A method for providing a multiple format wireless phone, said method comprising:
formatting at least one wireless module; and
providing a wireless phone with said wireless module.

2. A method for providing a multiple format wireless phone as recited in claim 1, wherein formatting at least one wireless module comprises utilizing at least one wireless format selected from the group consisting of CDMA ONE, CDMA 2000 1X, CDMA 2000 3X, CDMA 1X EV, Wideband CDMA, GSM, GPRS and EDGE.

3. A method for providing a multiple format wireless phone as recited in claim 1, wherein providing the wireless phone with said wireless module comprises providing said wireless module with at least one wireless format selected from the group consisting of CDMA ONE, CDMA 2000 1X, CDMA 2000 3X, CDMA 1X EV, Wideband CDMA, GSM, GPRS and EDGE.

4. A method for providing a multiple format wireless phone as recited in claim 1, further comprising providing said wireless module with an electronic serial number.

5. A method for providing a multiple format wireless phone as recited in claim 4, further comprising storing said electronic serial number.

6. A method for providing a multiple format wireless phone as recited in claim 4, further comprising providing said wireless module with a mobile station identification number.

7. A method for providing a multiple format wireless phone as recited in claim 6, further comprising:
storing said mobile station identification number; and
storing said electronic serial number.

8. A method for providing a multiple format wireless phone as recited in claim 7, wherein storing said mobile station identification number comprises storing said mobile station identification number to said wireless phone.

9. A method for providing a multiple format wireless phone as recited in claim 7, wherein storing said electronic serial number comprises storing said electronic serial number to said wireless phone.

10. A method for providing a multiple format wireless phone as recited in claim 5, wherein storing said electronic serial number comprises storing said electronic serial number to said wireless phone.

11. A system for providing a multiple format wireless phone, said system comprising:
a wireless phone configured to receive at least one wireless module; and
said wireless module in electronic data communication with said wireless phone, said wireless module configured to receive at least one wireless format.

12. A system for providing a multiple format wireless phone as recited in claim 11, wherein said wireless module configured to store operational data.

13. A system for providing a multiple format wireless phone as recited in claim 11, wherein said wireless format is selected from the group consisting of CDMA ONE, CDMA 2000 1X, CDMA 2000 3X, CDMA 1X EV, Wideband CDMA, GSM, GPRS and EDGE.

14. A system for providing a multiple format wireless phone as recited in claim 12, wherein said operational data comprises a mobile station identification number, said wireless phone configured to store said mobile station identification number.

15. A system for providing a multiple format wireless phone as recited in claim 12, wherein said operational data comprises an electronic serial number, said wireless phone configured to store said electronic serial number.

16. A system for providing a multiple format wireless phone as recited in claim 12, wherein said operation data comprises an electronic serial number and a mobile station identification number, said wireless phone configured to store said electronic serial number and said mobile station identification number.

17. A multiple format wireless phone comprising at least one wireless module configured to store operational data, said wireless module configured to be removably connected to the multiple format wireless phone.

18. A multiple format wireless phone as recited in claim 17, wherein said operational data comprises at least one wireless format.

19. A multiple format wireless phone as recited in claim 18, wherein said operational data further comprises an electronic serial number, the multiple format wireless phone configured to store said electronic serial number.

20. A multiple format wireless phone as recited in claim 19, wherein said operational data further comprises a mobile station serial number, the multiple format wireless phone configured to store said mobile station serial number.

21. A multiple format wireless phone as recited in claims 18, wherein said wireless format is selected from the group consisting of CDMA ONE, CDMA 2000 1X, CDMA 2000 3X, CDMA 1X EV, Wideband CDMA, GSM, GPRS and EDGE.
